(19) United States
(12) Patent Application Publication
(10) Pub. No.: US 2022/0317276 A1
(43) Pub. Date: Oct. 6, 2022

(54) RADAR SIGNAL PROCESSING DEVICE, RADAR SYSTEM, AND SIGNAL PROCESSING METHOD

(71) Applicant: Mitsubishi Electric Corporation, Tokyo (JP)

(72) Inventors: Masashi MITSUMOTO, Tokyo (JP); Kei SUWA, Tokyo (JP)

(73) Assignee: Mitsubishi Electric Corporation, Tokyo (JP)

(21) Appl. No.: 17/613,174

(22) PCT Filed: Jun. 6, 2019
(86) PCT No.: PCT/JP2019/022628

§ 371 Date: Nov. 22, 2021

(51) Int. Cl. G01S 13/58

(52) U.S. Cl. CPC G01S 13/584

(57) ABSTRACT

A radar signal processing device includes a frequency analysis unit for calculating a three-dimensional discrete frequency spectrum related to a first discrete frequency corresponding to a distance to a target object, a second discrete frequency corresponding to a relative speed of the target object, and a third discrete frequency corresponding to an angle of arrival of a series of frequency-modulated waves by performing first to third discrete orthogonal transform on digital received signals, a peak detection unit for detecting, for a discrete frequency value of at least one first search frequency, a discrete frequency value of a peak appearing in the three-dimensional discrete frequency spectrum in a direction of a second search frequency, and a maximum distribution detecting unit. The maximum distribution detecting unit focuses on a local intensity distribution including the peak and having a spread in directions of the first search frequency and the second search frequency, and determines whether or not the local intensity distribution forms a maximum distribution in the direction of the first search frequency.

### TECHNICAL FIELD

The present invention relates to a radar technology for measuring information on an object present at a distant position using frequency-modulated transmission waves.

### BACKGROUND ART

A radar technology for detecting an object present at a distant position using transmission waves having a modulation frequency that increases or decreases with time is widely used. In this type of radar technology, a scheme for linearly modulating the frequency of the transmission waves is called a chirp modulation scheme. Patent Literature 1 (JP 2018-115936 A) discloses a chirp modulation scheme called a fast chirp modulation (FCM) scheme. Hereinafter, the fast chirp modulation is referred to as “FCM”.

The radar device operating by the FCM scheme disclosed in Patent Literature 1 obtains received signals by receiving reflected waves from an object present at a distant position through an array antenna using transmission signals having frequencies modulated in a sawtooth waveform, and mixes the received signals and part of the transmission signals to generate beat signals. This radar device performs two-dimensional fast Fourier transform on the beat signals to obtain a two-dimensional spectrum regarding a frequency bin (discrete frequency) corresponding to a distance to an object and a frequency bin (discrete frequency) corresponding to a relative speed.

This radar device can detect a peak having a power value equal to or greater than a predetermined value in the two-dimensional spectrum, and can detect a distance and a relative speed to the object on the basis of a combination of two types of frequency bins in which the peak is present.

### CITATION LIST

### Patent Literature

Patent Literature 1: JP 2018-115936 A (See, for example, FIGS. 9A and 9B and paragraphs [0143] to [0161].)

### SUMMARY OF INVENTION

### Technical Problem

A high reflective object (for example, a vehicle) having a relatively high reflection intensity and a low reflective object (for example, human body) having a relatively low reflection intensity may simultaneously appear in the radar detection space. When the presence positions of the high reflective object and the low reflective object are close to each other, in the two-dimensional spectrum, a situation may occur in which only a peak indicating the presence of the high reflective object is clearly formed and a peak indicating the presence of the low reflective object is not clearly formed. In such a situation, it is difficult to simultaneously detect the high reflective object and the low reflective object.

In view of the above, an object of the present invention is to provide a radar signal processing device, a radar system, and a signal processing method capable of simultaneously detecting a high reflective object and a low reflective object that appear at positions close to each other within a radar detection space and identifying the high reflective object and the low reflective object with high accuracy.

### Solution to Problem

A radar signal processing device according to an aspect of the present invention is radar signal processing device used in a radar system including: an antenna array that includes a plurality of antenna elements arranged spatially and receives, by the plurality of antenna elements, a series of frequency-modulated waves reflected by a target object present within a radar detection space; and a receiving circuit that performs signal processing on output signals of the plurality of antenna elements and outputs digital received signals of a plurality of channels, the radar signal processing device including: a frequency analysis unit for calculating a three-dimensional discrete frequency spectrum related to a first discrete frequency corresponding to a distance to the target object, a second discrete frequency corresponding to a relative speed of the target object, and a third discrete frequency corresponding to an angle of arrival of the series of frequency-modulated waves by performing, on the digital received signals, a first discrete orthogonal transform related to time, a second discrete orthogonal transform related to continuous numbers assigned to the series of frequency-modulated waves, and a third discrete orthogonal transform related to sequence numbers assigned to the plurality of antenna elements; a peak detection unit for detecting, for a discrete frequency value of at least one first search frequency selected from among the first to third discrete frequencies, a discrete frequency value of a peak appearing in the three-dimensional discrete frequency spectrum in a direction of a second search frequency selected from among the first to third discrete frequencies; a maximum distribution detecting unit for focusing on a local intensity distribution including the peak and having a spread in directions of the first search frequency and the second search frequency, and determining whether or not the local intensity distribution forms a maximum distribution in the direction of the first search frequency; and a target information calculating unit for calculating information on the target using the discrete frequency value of the first search frequency and the discrete frequency value of the peak in a case in which it is determined that the local intensity distribution forms the maximum distribution.

### Advantageous Effects of Invention

According to an aspect of the present invention, it is possible to simultaneously detect a high reflective object and a low reflective object appearing at positions close to each other in a radar detection space, and to identify the high reflective object and the low reflective object with high accuracy.

### BRIEF DESCRIPTION OF DRAWINGS

FIG. 1 is a diagram illustrating a schematic configuration of a radar system of a first embodiment according to the present invention.

FIG. 2 is a graph illustrating an example of a time-varying frequency of a transmission wave and a time-varying frequency of a received wave by a fast chirp modulation scheme.

FIG. 3 is a block diagram illustrating a schematic configuration of a hardware configuration example of a radar signal processing device of the first embodiment.

FIG. 4 is a block diagram illustrating a configuration of a calculation unit in the radar signal processing device of the first embodiment.

FIG. 5 is a flowchart illustrating an example of an operation procedure of the calculation unit of the first embodiment.

FIG. 6 is a diagram for explaining a concept of a three-dimensional discrete frequency spectrum.

FIG. 7 is a graph illustrating an example of a two-dimensional discrete frequency spectrum extracted from the three-dimensional discrete frequency spectrum.

FIG. 8 is a graph illustrating another example of the two-dimensional discrete frequency spectrum extracted from the three-dimensional discrete frequency spectrum.

FIG. 9 is a flowchart illustrating a specific example of an operation procedure of a target detection unit of the first embodiment.

FIGS. 10A and 10B are diagrams illustrating a positional relationship between a mobile object on which the radar system of the first embodiment is mounted and a radio wave reflection source.

### DESCRIPTION OF EMBODIMENTS

Hereinafter, embodiments according to the present invention will be described in detail with reference to the drawings. Note that components given the same reference numerals throughout the drawings have the same configuration and the same function.

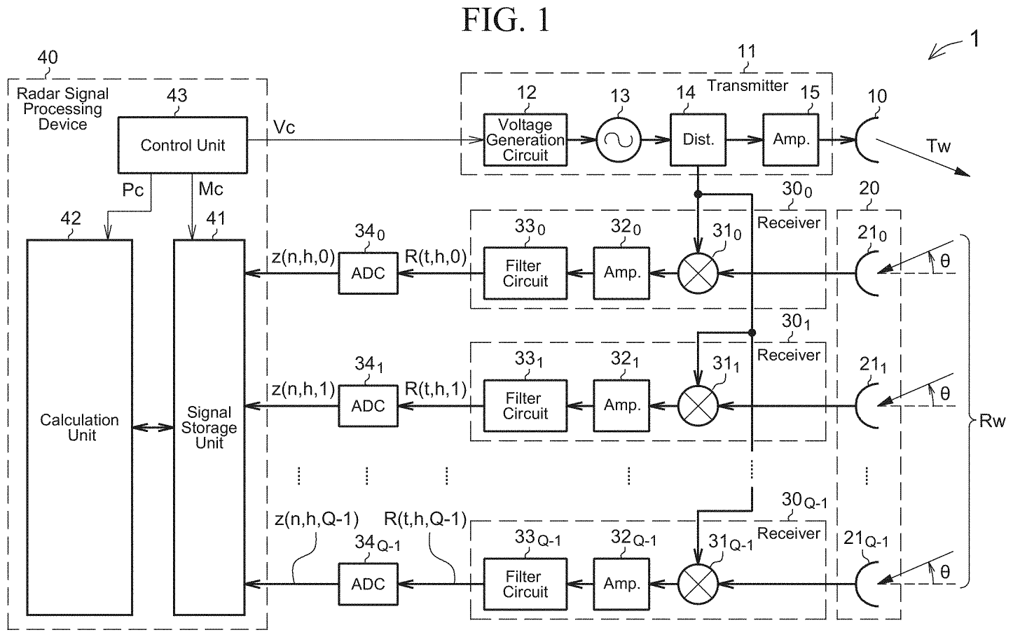

FIG. 1 is a diagram illustrating a schematic configuration of a radar system 1 of a first embodiment according to the present invention. The radar system 1 illustrated in FIG. 1 includes a transmitter 11 that continuously generates a series of frequency-modulated wave signals in a high frequency band such as a microwave band, a millimeter wave band, or a quasi-millimeter wave band, a transmission antenna 10 that transmits a series of frequency-modulated waves (transmission waves) Tw toward a radar detection space on the basis of an output signal of the transmitter 11, an antenna array 20 including receiving antenna elements 21₀, . . . , and 21_{Q-1} that receive frequency-modulated waves (received waves) Rw scattered or reflected by a target object (not shown) present within the radar detection space, and receivers 30₀, . . . , and 30_{Q-1} that perform analog signal processing on output signals of the receiving antenna elements 21₀, . . . , and 21_{Q-1} and output analog received signals R(t, h, 0), . . . , and R(t, h, Q−1) of Q channels (Q receiving channels).

Here, the number Q of the receiving antenna elements 21₀ to 21_{Q-1} is an integer equal to or greater than three, but is not limited thereto. In the analog received signals R(t, h, 0) to R(t, h, Q−1), t is time, and his an integer in a range of 0 to H−1 indicating continuous numbers assigned to frequency-modulated waves (received waves) received from a target object.

In addition, the radar system 1 includes A/D converters (ADC) 34₀, . . . , and 34_{Q-1} that convert analog received signals R (t, h, 0), . . . , and R (t, h, Q−1) of Q channels into digital received signals z(n, h, 0), . . . , and z(n, h, Q−1) of Q channels, and a radar signal processing device 40 that performs digital signal processing on the digital received signals z(n, h, 0), . . . , and z(n, h, Q−1) to calculate target information such as a distance to the target object, a relative speed of the target object, and an angle of arrival θ of a frequency-modulated wave Rw from the target object. Each A/D converter 34_{q} samples an analog received signal R(t, h, q) at a predetermined sampling period to generate a digital received signal z(n, h, q). Here, q is an integer within a range of 0 to Q−1 indicating the sequence number of a q-th receiving antenna element 21q, n is an integer within a range of 0 to N−1 indicating a sampling number, and N is the number of sampling points. The receiving circuit of the present embodiment includes receivers 30₀, . . . , and 30_{Q-1} and A/D converters 34₀, . . . , and 34_{Q-1}.

The transmitter 11 includes a voltage generation circuit 12, a voltage-controlled oscillator 13, a distribution circuit 14, and an amplifier circuit 15. The voltage generation circuit 12 generates a modulation voltage according to the control signal Vc supplied from the radar signal processing device 40, and supplies the modulation voltage to the voltage-controlled oscillator 13. The voltage-controlled oscillator 13 repeatedly outputs a frequency-modulated wave signal having a modulation frequency that increases or decreases with time depending on the modulation voltage in accordance with a predetermined frequency modulation system. The distribution circuit 14 distributes the frequency-modulated wave signal input from the voltage-controlled oscillator 13 into a transmission wave signal and a local signal. The distribution circuit 14 supplies the transmission wave signal to the amplifier circuit 15 and supplies the local signal to the receivers 30₀, . . . , and 30_{Q-1}. The amplifier circuit 15 amplifies the transmission wave signal. Then, the transmission antenna 10 transmits the frequency-modulated wave Tw toward the radar detection space on the basis of the output signal of the amplifier circuit 15.

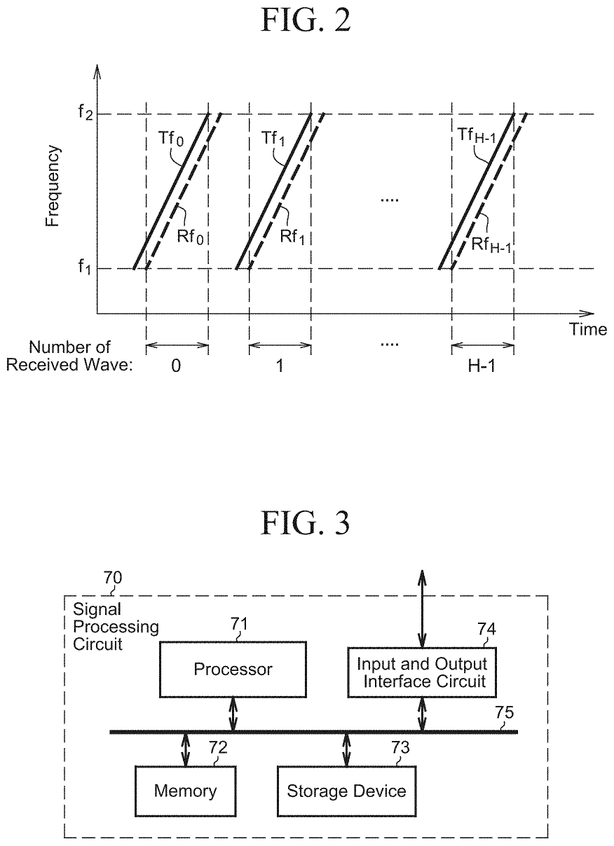

As a frequency modulation system, a frequency modulated continuous wave (FMCW) system can be used. The frequency of the frequency-modulated wave signal, that is, the transmission frequency may be swept so as to continuously increase or decrease with time within a certain frequency band. FIG. 2 is a graph illustrating an example of time-varying frequencies Tf₀ to Tf_{H-1} of transmission waves and time-varying frequencies Rf₀ to Rf_{H-1} of received waves by a fast chirp modulation (FCM) scheme which is one type of FMCW system. The frequency Tfₕ of the h-th transmission wave (h is an integer in the range of 0 to H−1) is linearly modulated so as to continuously increase from the designated lower limit frequency f₁ to the designated upper limit frequency f₂ with time. Since the received waves are received with a delay with respect to the transmission waves, the frequencies Rf₀ to Rf_{H-1} of the received waves are shifted backward in time with respect to the frequencies Tf₀ to Tf_{H-1} of the transmission waves.

Referring to FIG. 1, each receiver 30_{q} includes a mixer 31_{q} that mixes the output signal of the receiving antenna element 21_{q} and the local signal supplied from the distribution circuit 14 to generate a beat signal, an amplifier circuit 32_{q} such as a low noise amplifier (LNA) that amplifies the beat signal, and a filter circuit 33_{q} that suppresses unnecessary frequency components in the output signal of the amplifier circuit 32_{q} and outputs an analog received signal R(t, h, q). The A/D converter 34_{q} converts the analog received signal R(t, h, q) into a digital received signal z(n, h, q) and supplies the digital received signal z(n, h, q) to the radar signal processing device 40. The digital received signal z(n, h, q) is a complex signal having an in-phase component and a quadrature-phase component. Hereinafter, the digital received signal will be referred to as a “received signal”.

The radar signal processing device 40 includes a signal storage unit 41 for temporarily storing the received signals z(n, h, 0) to z(n, h, Q−1) output in parallel from the A/D converters 34₀, . . . , and 34_{Q-1}, a calculation unit 42 for performing digital signal processing on the received signals z(n, h, 0) to z(n, h, Q−1) read from the signal storage unit 41 to calculate target information such as a distance to a target object, a relative speed of the target object, and an angle of arrival θ of the frequency-modulated wave Rw from the target object, and a control unit 43 for controlling operations of the transmitter 11, the signal storage unit 41, and the calculation unit 42. As the signal storage unit 41, a random access memory (RAM) capable of achieving a high-speed response time required for radar signal processing may be used. The control unit 43 supplies a control signal Vc for generating a modulation voltage to the voltage generation circuit 12, supplies a control signal Mc for reading and writing a signal to the signal storage unit 41, and supplies a control signal Pc for controlling the operation of the calculation unit 42 to the calculation unit 42.

All or some of the functions of the radar signal processing device 40 can be implemented using, for example, a single or a plurality of processors having a semiconductor integrated circuit such as a digital signal processor (DSP), an application specific integrated circuit (ASIC), or a programmable logic device (PLD). Here, the PLD is a semiconductor integrated circuit whose function can be freely changed by a designer after manufacturing of the PLD. Examples of the PLD include a field-programmable gate array (FPGA). Alternatively, all or some of the functions of the radar signal processing device 40 may be implemented using a single or a plurality of processors including an arithmetic device such as a central processing unit (CPU) or a graphics processing unit (GPU) that executes program codes of software or firmware. Alternatively, all or some of the functions of the radar signal processing device 40 can be also implemented using a single or a plurality of processors including a combination of a semiconductor integrated circuit such as a DSP, an ASIC, or a PLD and an arithmetic device such as a CPU or a GPU.

FIG. 3 is a block diagram illustrating a schematic configuration of a signal processing circuit 70 which is a hardware configuration example of the radar signal processing device 40 of the first embodiment. The signal processing circuit 70 illustrated in FIG. 3 includes a processor 71, an input and output interface circuit 74, a memory 72, a storage device 73, and a signal path 75. The signal path 75 is a bus for connecting the processor 71, the input and output interface circuit 74, the memory 72, and the storage device 73 to each other. The input and output interface circuit 74 has a function of transferring a digital signal input from the outside to the processor 71, and has a function of outputting the digital signal transferred from the processor 71 to the outside.

The memory 72 includes a work memory used when the processor 71 executes digital signal processing and a temporary storage memory in which data used in the digital signal processing is loaded. For example, the memory 72 may include a semiconductor memory such as a flash memory or a synchronous dynamic random access memory (SDRAM). Furthermore, in a case in which the processor 71 includes an arithmetic device such as a CPU or a GPU, the storage device 73 can be used as a storage medium that stores codes of a signal processing program of software or firmware to be executed by the arithmetic device. For example, the storage device 73 may include a nonvolatile semiconductor memory such as a flash memory or a read only memory (ROM).

Note that, in the example of FIG. 3, the number of processors 71 is one, but is not limited thereto. A hardware configuration of the radar signal processing device 40 may be implemented using a plurality of processors operating in cooperation with each other.

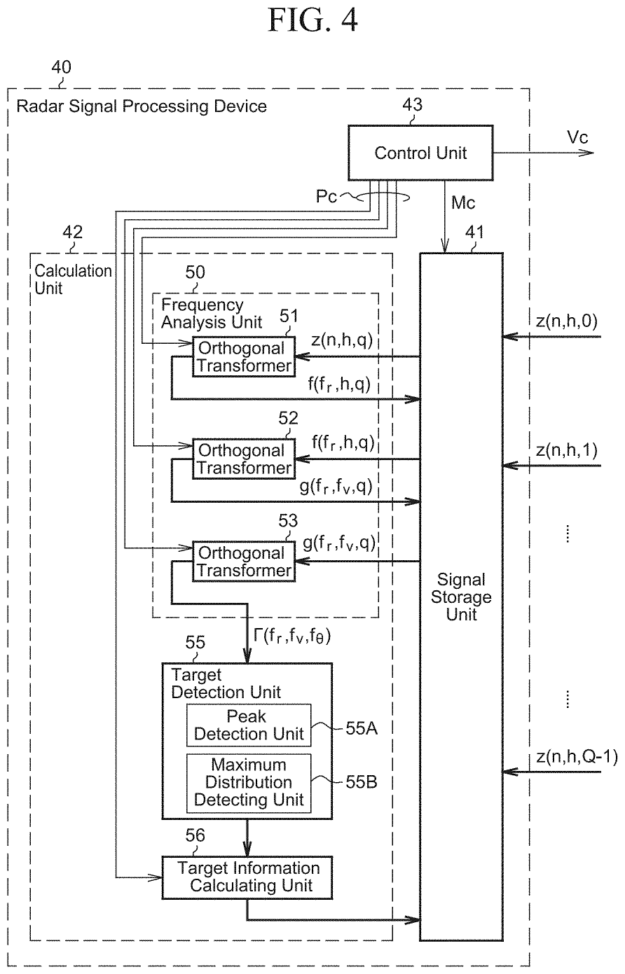

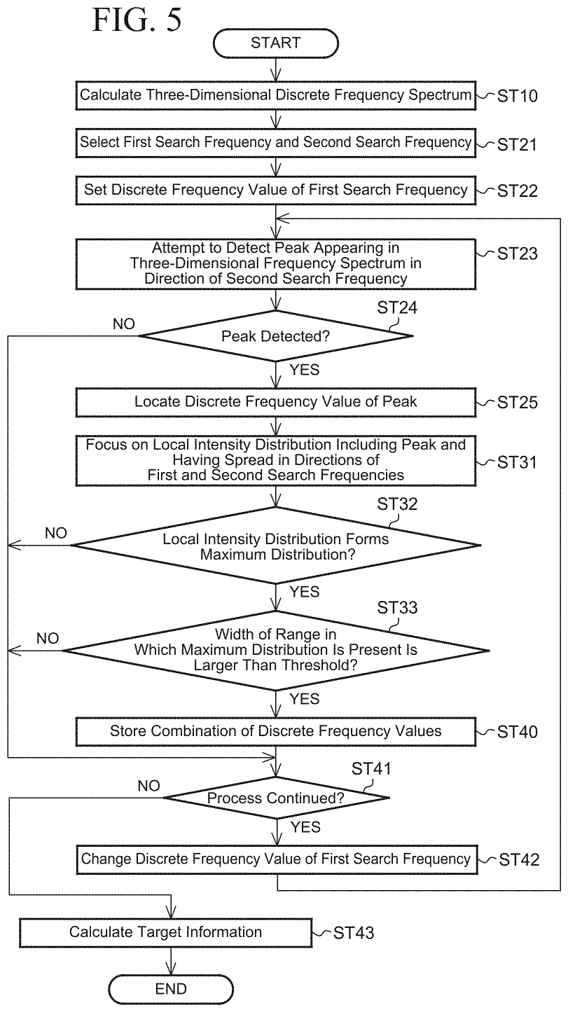

Next, the configuration and operation of the calculation unit 42 in the radar signal processing device 40 of the first embodiment will be described with reference to FIGS. 4 and 5. FIG. 4 is a block diagram illustrating a configuration of the calculation unit 42 in the radar signal processing device 40 of the first embodiment. FIG. 5 is a flowchart illustrating an example of an operation procedure of the calculation unit 42.

As illustrated in FIG. 4, the calculation unit 42 includes a frequency analysis unit 50, a target detection unit 55, and a target information calculating unit 56. The frequency analysis unit 50 has orthogonal transformers 51, 52, and 53, and the target detection unit 55 has a peak detection unit 55A and a maximum distribution detecting unit 55B. Each of the orthogonal transformers 51 to 53 has a function of executing discrete orthogonal transform such as discrete Fourier transform (DFT) in accordance with the control signal Pc supplied from the control unit 43. As the discrete Fourier transform, a fast Fourier transform (FFT) algorithm may be executed.

The frequency analysis unit 50 calculates a three-dimensional discrete frequency spectrum Γ(fᵣ, fᵥ, f_{θ}) on the basis of the received signal z(n, h, q) read from the signal storage unit 41 (step ST10 in FIG. 5).

Specifically, the orthogonal transformer (first orthogonal transformer) 51 executes the first discrete orthogonal transform related to the sampling number n corresponding to time on the received signal z(n, h, q) read from the signal storage unit 41 to calculate a frequency domain signal f(fᵣ, h, q) related to the first discrete frequency fᵣ corresponding to the distance to the target object, and stores the frequency domain signal f(fᵣ, h, q) in the signal storage unit 41. Here, the first discrete frequency fᵣ takes any one of discrete frequency values of N points corresponding to sampling numbers n=0 to N−1. The frequency domain signal f(fᵣ, h, q) is a complex signal having an in-phase component and a quadrature-phase component. Hereinafter, for convenience of description, the first discrete frequency will be referred to as a “distance frequency”.

The orthogonal transformer (second orthogonal transformer) 52 executes the second discrete orthogonal transform related to the continuous number h assigned to the frequency-modulated wave on the frequency domain signal f(fᵣ, h, q) read from the signal storage unit 41 to calculate a frequency domain signal g(fᵣ, fᵥ, q) related to a second discrete frequency corresponding to the relative speed of the target object, and stores the frequency domain signal g(fᵣ, fᵥ, q) in the signal storage unit 41. Here, the second discrete frequency fᵥ takes any one of discrete frequency values of H points corresponding to the continuous numbers h=0 to H−1. The frequency domain signal g(fᵣ, fᵥ, q) is a complex signal having an in-phase component and a quadrature-phase component. Hereinafter, for convenience of description, the second discrete frequency will be referred to as a “speed frequency”.

The orthogonal transformer (third orthogonal transformer) 53 executes the third discrete orthogonal transform related to the sequence number q assigned to the receiving antenna element 21_{q} on the frequency domain signal g(fᵣ, fᵥ, q) read from the signal storage unit 41 to calculate a frequency domain signal γ(fᵣ, fᵥ, f_{θ}) related to the third discrete frequency f_{θ} corresponding to the angle of arrival θ of the received wave, and calculate the three-dimensional discrete frequency spectrum Γ(fᵣ, fᵥ, f_{θ}) from the frequency domain signal γ(fᵣ, fᵥ, f_{θ}). Here, the third discrete frequency f_{θ} takes any one of discrete frequency values of Q points corresponding to the sequence numbers: q=0 to Q−1. The frequency domain signal γ(fᵣ, fᵥ, f_{θ}) is a complex signal having an in-phase component and a quadrature-phase component. Hereinafter, for convenience of description, the third discrete frequency will be referred to as an “angular frequency”.

Note that, in the present embodiment, the first discrete orthogonal transform, the second discrete orthogonal transform, and the third discrete orthogonal transform are executed in this order, but this is not a limitation.

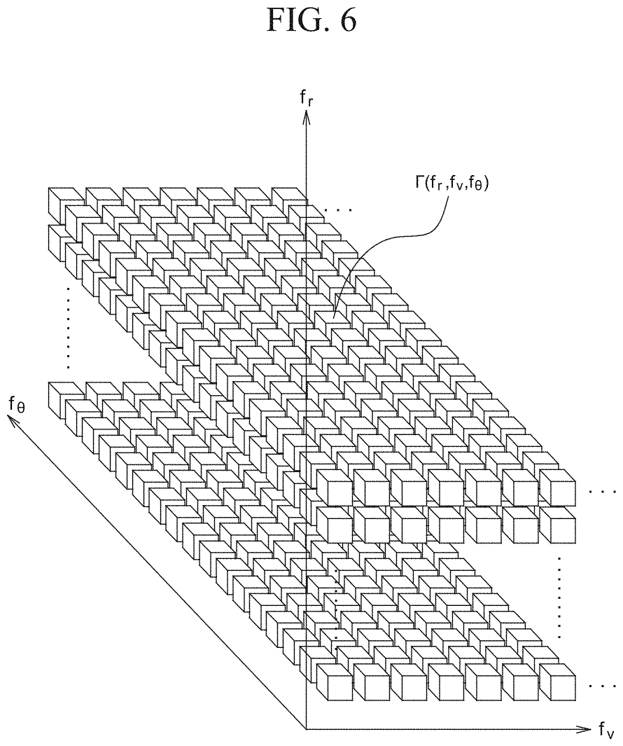

The three-dimensional discrete frequency spectrum Γ(fᵣ, fᵥ, f_{θ}) is an intensity distribution of the frequency domain signal γ(fᵣ, fᵥ, f_{θ}) related to the distance frequency fᵣ, the speed frequency fᵥ, and the angular frequency f_{θ}. FIG. 6 is a diagram for explaining a concept of a three-dimensional discrete frequency spectrum Γ(fᵣ, fᵥ, f_{θ}), and illustrates a relationship between a combination (fᵣ, fᵥ, f_{θ}) of a distance frequency fᵣ, a speed frequency fᵥ, and an angular frequency f_{θ} and a signal intensity. In FIG. 6, each discrete intensity value of the three-dimensional discrete frequency spectrum Γ(fᵣ, fᵥ, f_{θ}) is represented by a cubic cell.

After calculating the three-dimensional discrete frequency spectrum Γ(fᵣ, fᵥ, f_{θ}) (step ST10), the peak detection unit 55A of the target detection unit 55 selects the first search frequency fₓ, f_{y} (for example, fᵣ, fᵥ) and the second search frequency f_{y} (for example, f_{θ}) from among the distance frequency fᵣ, the speed frequency fᵥ, and the angular frequency f_{θ} (step ST21), and sets the discrete frequency values Fₓ, F_{y} of the first search frequencies fₓ, f_{y} to initial values (step ST22). In the present embodiment, two first search frequencies fₓ, f_{y} are selected in step ST22, but this is not a limitation. There may be an embodiment in which one first search frequency is selected.

Next, the peak detection unit 55A attempts to detect a peak appearing in the three-dimensional discrete frequency spectrum Γ(fᵣ, fᵥ, f_{θ}) in the direction of the second search frequency f_{z} with respect to the discrete frequency values Fₓ, F_{y} set in step ST22 (step ST23). If no peak is detected (NO in step ST24), the peak detection unit 55A shifts the process to step ST41. On the other hand, if a peak is detected (YES in step ST24), the peak detection unit 55A locates a discrete frequency value P_{z} of the peak (step ST25). Here, the discrete frequency value P_{z} is a discrete frequency value of the second search frequency G.

Specifically, the peak detection unit 55A can detect a peak appearing in the one-dimensional intensity distribution obtained from the three-dimensional discrete frequency spectrum Γ(fᵣ, fᵥ, f_{θ}) when the discrete frequency value of the second search frequency f_{z} is changed (scanned) with respect to the set discrete frequency values Fₓ, F_{y}, and can locate the discrete frequency value P_{z} (for example, the peak frequency value) of the peak.

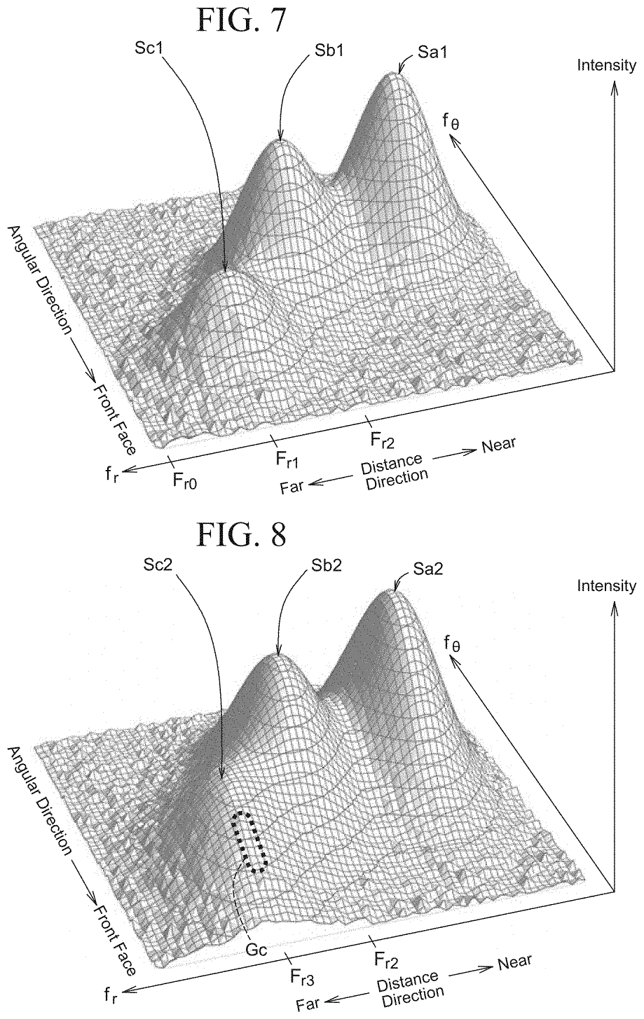

FIG. 7 is a graph illustrating an example of a two-dimensional discrete frequency spectrum extracted from a three-dimensional discrete frequency spectrum Γ(fᵣ, fᵥ, f_{θ}). In FIG. 7, a two-dimensional discrete frequency spectrum related to the distance frequency fᵣ and the angular frequency f_{θ} is displayed. The two-dimensional discrete frequency spectrum includes intensity distributions Sa1, Sb1, and Sc1 each corresponding to one of three radio wave reflection sources. Now, consider a case in which the distance frequency fᵣ is selected as the first search frequency and the angular frequency f_{θ} is selected as the second search frequency. As illustrated in FIG. 7, when the discrete frequency value Fᵣ₀ of the first search frequency fᵣ is set, no peak appears in the two-dimensional discrete frequency spectrum in the direction of the second search frequency f_{θ}. On the other hand, when the discrete frequency value Fᵣ₁ of the first search frequency fᵣ is set as illustrated in FIG. 7, since a peak of the intensity distribution Sc1 is present in the direction of the second search frequency f_{θ}, the peak detection unit 55A can detect the peak and locate the discrete frequency value of the peak. In addition, when the discrete frequency value Fᵣ₂ of the first search frequency fᵣ is set as illustrated in FIG. 7, since a peak of the intensity distribution Sb1 is present in the direction of the second search frequency f_{θ}, the peak detection unit 55A can detect the peak and locate the discrete frequency value of the peak.

After step ST25, the maximum distribution detecting unit 55B focuses on a local intensity distribution that includes the detected peak and has a spread in the directions of the first search frequencies fₓ, f_{y} and the second search frequency f_{z} in the three-dimensional discrete frequency spectrum Γ(fᵣ, fᵥ, f_{θ}) (step ST31). For example, the maximum distribution detecting unit 55B can focus on a local intensity distribution that includes the peak and has an intensity larger than the intensity threshold in the three-dimensional discrete frequency spectrum Γ(fᵣ, fᵥ, f_{θ}).

Next, the maximum distribution detecting unit 55B determines whether or not the local intensity distribution forms a maximum distribution in at least one direction of the first search frequencies fₓ, f_{y} (step ST32).

Now, consider a case in which the distance frequency fᵣ is selected as the first search frequency and the angular frequency f_{θ} is selected as the second search frequency. When the discrete frequency value Fᵣ₁ of the first search frequency fᵣ is set as illustrated in FIG. 7, the maximum distribution detecting unit 55B focuses on a local intensity distribution that includes the peak of the intensity distribution Sc1 and has a spread in the directions of the first search frequency fᵣ and the second search frequency f_{θ}. Since the local intensity distribution forms a maximum distribution in the direction of the first search frequency fᵣ at the peak of the intensity distribution Sc1 and the vicinity thereof as illustrated in FIG. 7, the maximum distribution detecting unit 55B can detect the maximum distribution. In addition, as illustrated in FIG. 7, when the discrete frequency value Fᵣ₂ of the first search frequency fᵣ is set, the maximum distribution detecting unit 55B focuses on a local intensity distribution that includes the peak of the intensity distribution Sb1 and has a spread in the directions of the first search frequency fᵣ and the second search frequency f_{θ}. Since the local intensity distribution forms a maximum distribution in the direction of the first search frequency fᵣ at the peak of the intensity distribution Sb 1 and the vicinity thereof as illustrated in FIG. 7, the maximum distribution detecting unit 55B can detect the maximum distribution.

On the other hand, FIG. 8 is a graph illustrating another example of the two-dimensional discrete frequency spectrum extracted from the three-dimensional discrete frequency spectrum Γ(fᵣ, fᵥ, f_{θ}). In FIG. 8, a two-dimensional discrete frequency spectrum related to the distance frequency fᵣ and the angular frequency f_{θ} is displayed. The two-dimensional discrete frequency spectrum includes intensity distributions Sa2, Sb2, and Sc2 each corresponding to one of three radio wave reflection sources. In this case, when the discrete frequency value Fᵣ₂ of the first search frequency fᵣ is set as illustrated in FIG. 8, the maximum distribution detecting unit 55B focuses on a local intensity distribution that includes a peak of the intensity distribution Sb2 and has a spread in the directions of the first search frequency fᵣ and the second search frequency f_{θ}. Since the local intensity distribution forms a maximum distribution in the direction of the first search frequency fᵣ at the peak of the intensity distribution Sb2 and the vicinity thereof as illustrated in FIG. 8, the maximum distribution detecting unit 55B can detect the maximum distribution.

As illustrated in FIG. 8, when the discrete frequency value Fra of the first search frequency fᵣ is set, the peak detection unit 55A detects a peak of the intensity distribution Sc2. The maximum distribution detecting unit 55B focuses on a local intensity distribution that includes the peak of the intensity distribution Sc2 and has a spread in the directions of the first search frequency fᵣ and the second search frequency f_{θ}. The local intensity distribution does not form a maximum distribution in the direction of the first search frequency fᵣ at the peak of the intensity distribution Sc2 and the vicinity thereof, but forms a maximum distribution in the direction of the first search frequency fᵣ in the inclined portion Gc of the intensity distribution Sc2. Therefore, the maximum distribution detecting unit 55B can detect the maximum distribution.

In the example of FIG. 8, the peak of the intensity distribution Sc2 clearly appears in the direction of the second search frequency f_{θ}, but does not clearly appear in the direction of the first search frequency fᵣ. Even in such a case, the maximum distribution detecting unit 55B can determine that the peak is due to a radio wave reflection source by detecting the maximum distribution of the inclined portion Gc in the direction of the first search frequency fᵣ.

When it is determined in step ST32 that the local intensity distribution does not form a maximum distribution (NO in step ST32), the maximum distribution detecting unit 55B shifts the process to step ST41. On the other hand, when it is determined that the local intensity distribution forms the maximum distribution (YES in step ST32), the maximum distribution detecting unit 55B determines whether or not a width Δf_{z} of the range in which the maximum distribution is present in the direction of the second search frequency f_{z} is larger than the threshold (step ST33). When it is determined that the width Δf_{z} of the range in which the maximum distribution is present is not larger than the threshold (NO in step ST33), the maximum distribution detecting unit 55B shifts the process to step ST41. This can prevent erroneous detections of radio wave reflection sources.

On the other hand, when it is determined that the width Δf_{z} of the range in which the maximum distribution is present is larger than the threshold (YES in step ST33), the maximum distribution detecting unit 55B stores a combination of the discrete frequency values Fₓ, F_{y} of the first search frequencies fₓ, f_{y} and the discrete frequency value P_{z} of the peak (step ST40).

In step ST41 after step ST40, the control unit 43 determines whether or not to continue the loop process. When the control unit 43 determines to continue the loop process (YES in step ST41), the peak detection unit 55A changes the discrete frequency values Fₓ, F_{y} of the first search frequencies fₓ, f_{y} (step ST42). Thereafter, step ST23 is executed.

On the other hand, when the control unit 43 determines not to continue the loop process (NO in step ST41), the target information calculating unit 56 calculates the target information on the target object (radio wave reflection source) using the discrete frequency values Fₓ, F_{y} of the first search frequencies fₓ, f_{y} and the discrete frequency value P_{z} of the peak on the basis of the principle based on the FMCW system (step ST43). The calculated target information is stored in the signal storage unit 41.

Now, in a case where the discrete frequency values Fₓ, F_{y}, P_{z} include a combination of the discrete frequency value Fᵣ of the distance frequency fᵣ, the discrete frequency value Fᵥ of the speed frequency fᵥ, and the discrete frequency value F_{θ}of the angular frequency f_{θ}, the target information calculating unit 56 can calculate a distance Dst to the target object, and a relative speed Spd and an angle of arrival θ of the target object, on the basis of the principle of the FMCW radar.

For example, the target information calculating unit 56 can calculate the distance Dst and the relative speed Spd according to the following expressions (1) and (2).

Dst=(c×T×Fᵣ)/(2×B) (1)

Spd=λ×Fᵥ/2 (2)

Here, c is a propagation speed of the transmission wave, T is a modulation time width of the transmission wave, B is a modulation frequency width of the transmission wave, and λ is a wavelength of the transmission wave.

Furthermore, in a case in which the antenna array 20 constitutes a linear array antenna, the receiving antenna elements 21₀, . . . , and 21_{Q-1} are arranged at equal intervals. In this case, for example, the target information calculating unit 56 can calculate the angle of arrival θ=Ag1 according to the following expression (3) on the basis of the principle of digital beam forming.

Ag1=Arcsin(b×λ/(L×Q)) (3)

Here, b is a number corresponding to a discrete frequency value F_{θ} based on FFT (Fast Fourier Transform), L is an interval between the receiving antenna elements 21₀ to 21_{Q-1}, and Q is the number of FFT points.

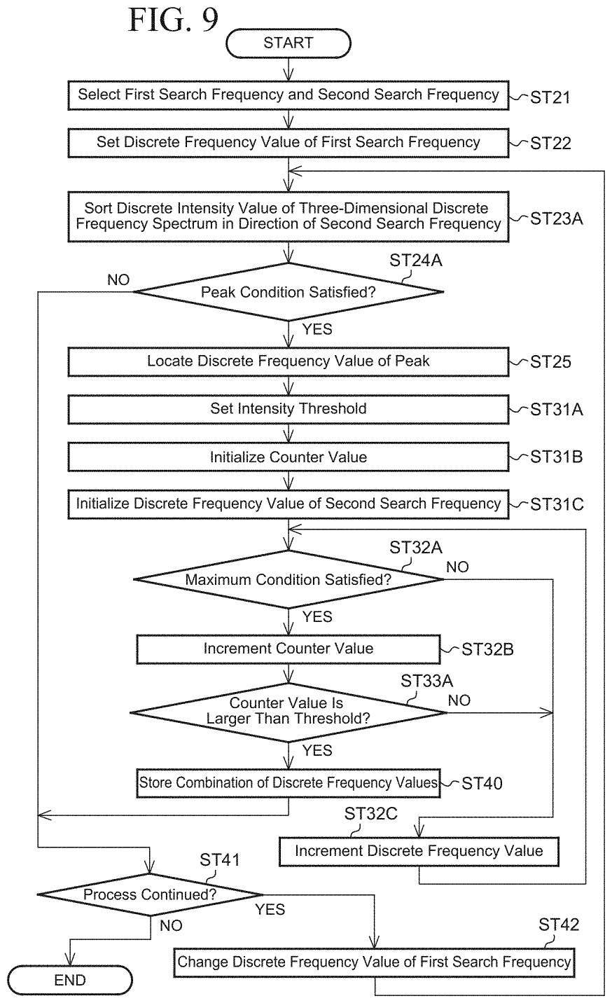

Next, a more specific example of the operation procedure of the target detection unit 55 of the first embodiment will be described with reference to FIG. 9. FIG. 9 is a flowchart illustrating a specific example of the operation procedure of the target detection unit 55.

Referring to FIG. 9, similarly to steps ST21, ST22 in FIG. 5, the peak detection unit 55A selects the first search frequencies fₓ, f_{y} (for example, fᵣ, fᵥ) and the second search frequency f_{y} (for example, f_{θ}) from among the distance frequency fᵣ, the speed frequency fᵥ, and the angular frequency f_{θ} (step ST21), and sets the discrete frequency values Fₓ, F_{y} of the first search frequencies fₓ, f_{y} to initial values (step ST22).

Next, the peak detection unit 55A sorts the discrete intensity values of the three-dimensional discrete frequency spectrum Γ(fᵣ, fᵥ, f_{θ}) at the second search frequency f_{z} in ascending or descending order (step ST23A). Next, the peak detection unit 55A determines whether or not a set of discrete intensity values satisfies a peak condition on the basis of a result obtained by the sorting (the set of discrete intensity values rearranged in ascending or descending order) (step ST24A). If the peak condition is not satisfied (NO in step ST24A), the peak detection unit 55A shifts the process to step ST41.

Now, for the discrete frequency values Fₓ, F_{y}, it is assumed that the three-dimensional discrete frequency spectrum Γ(fᵣ, fᵥ, f_{θ}) has L discrete intensity values I₂, . . . , I_{L-1}, I_{L} in the direction of the second search frequency f_{z}. Here, L is a positive integer.

On the basis of the result obtained by sorting, the peak detection unit 55A can determine that the peak condition is satisfied when the absolute difference value between the K-th discrete intensity value (K is a predetermined positive integer smaller than L) from the largest one of the discrete intensity values I₁ to I_{L} and the J-th discrete intensity value (J is a predetermined positive integer smaller than L-K) from the smallest one of the discrete intensity values I₁ to I_{L} exceeds the threshold (YES in step ST24A). At this time, it is assumed that there is a peak in the three-dimensional discrete frequency spectrum Γ(fᵣ, fᵥ, f_{θ}) in the direction of the second search frequency f_{z}. In addition, it is determined that there is a high possibility that the set of the discrete intensity values I₁ to I_{L} includes the discrete intensity value corresponding to the target object (radio wave reflection source).

When it is determined that the peak condition is satisfied (YES in step ST24A), the peak detection unit 55A detects a local maximum value from among the discrete intensity values I₁ to I_{L}, and locates a discrete frequency value P_{z} corresponding to the local maximum value as a discrete frequency value of a peak appearing in the three-dimensional discrete frequency spectrum Γ(fᵣ, fᵥ, f_{θ}) (step ST25).

Next, the maximum distribution detecting unit 55B sets an intensity threshold Th as a value obtained by multiplying the J₂-th discrete intensity value from the smallest one among the discrete intensity values I₁ to I_{L} by a predetermined coefficient on the basis of the result obtained by sorting (step ST31A). Here, J₂ is a predetermined positive integer.

Subsequently, the maximum distribution detecting unit 55B initializes a counter value (step ST31B) and initializes the discrete frequency value F_{z} of the second search frequency f_{z} (step ST31C). Then, the maximum distribution detecting unit 55B determines whether or not the maximum condition is satisfied (step ST32A). Now, a discrete intensity value in a combination of discrete frequency values (Fₓ, F_{y}, F_{z}) is represented as I(Fₓ, F_{y}, F_{z}). In a case in which the following expressions (4), (5), and (6) are satisfied, in a case in which the following expressions (4), (7), and (8) are satisfied, or in a case in which the following expressions (4) to (8) are satisfied, the maximum distribution detecting unit 55B can determine that the maximum condition is satisfied (YES in step ST32A).

I(Fₓ,F_{y},F_{z})>Th (4)

I(Fₓ,F_{y},F_{z})>I(Fₓ+1,F_{y},F_{z}) (5)

I(Fₓ,F_{y},F_{z})>I(Fₓ−1,F_{y},F_{z}) (6)

I(Fₓ,F_{y},F_{z})>I(Fₓ,F_{y}+1,F_{z}) (7)

I(Fₓ,F_{y},F_{z})>I(Fₓ,F_{y}−1,F_{z}) (8)

When it is determined that the maximum condition is satisfied (YES in step ST32A), it is determined that a local intensity distribution having an intensity larger than the intensity threshold Th forms a maximum distribution in the direction of the first search frequency f_{z}. On the other hand, when it is determined that the maximum condition is not satisfied (NO in step ST32A), the maximum distribution detecting unit 55B shifts the process to step ST32C.

When the maximum condition is satisfied (YES in step ST32A), the maximum distribution detecting unit 55B increments the counter value (step ST32B), and determines whether or not the count value is larger than a threshold (step ST33A). If the count value is larger than the threshold (YES in step ST33A), it is determined that the width of the range in which the maximum distribution is present in the direction of the second search frequency f_{z} is larger than the threshold. In this case, the maximum distribution detecting unit 55B stores a combination of the discrete frequency values Fₓ, F_{y} of the first search frequencies fₓ, f_{y} and the discrete frequency value P_{z} of the peak (step ST40), and shifts the process to step ST41.

In a case where the count value is not larger than the threshold (NO in step ST33A), the maximum distribution detecting unit 55B increments the discrete frequency value F_{z} of the second search frequency f_{z} (step ST32C), and executes step ST32A.

In step ST41, the control unit 43 determines whether or not to continue the loop process. When the control unit 43 determines to continue the loop process (YES in step ST41), the peak detection unit 55A changes the discrete frequency values Fₓ, F_{y} of the first search frequencies fₓ, f_{y} (step ST42). Thereafter, the peak detection unit 55A executes step ST23A. On the other hand, the control unit 43, when determining not to continue the loop process (NO in step ST41), ends the target detection process.

As described above, in the first embodiment, the peak detection unit 55A detects a peak appearing in the three-dimensional discrete frequency spectrum Γ(fᵣ, fᵥ, f_{θ}) in the direction of the second search frequency f_{z} with respect to the discrete frequency values Fₓ, F_{y} of the first search frequencies fₓ, f_{y}, and locates the discrete frequency value P_{z} of the peak. The maximum distribution detecting unit 55B focuses on a local intensity distribution that includes the peak and has a spread in the directions of the first and second search frequencies fₓ, f_{y}, f_{z}, and determines whether or not the local intensity distribution forms a maximum distribution in at least one direction of the first search frequencies fₓ, f_{y}. If it is determined that the maximum distribution is formed, then the target information detecting unit 56 calculates the target information using the discrete frequency values Fₓ, F_{y}, P_{z}. Therefore, even if the peak does not appear clearly in the direction of the first search frequencies fₓ, f_{y} in the three-dimensional discrete frequency spectrum Γ(fᵣ, fᵥ, f_{θ}), if the peak appears clearly in the direction of the second search frequency f_{z}, then the radar signal processing device 40 can detect the target object and calculate the target information. Therefore, the radar signal processing device 40 can simultaneously detect a high reflective object and a low reflective object appearing at positions close to each other in the radar detection space, and can identify the high reflective object and the low reflective object with high accuracy.

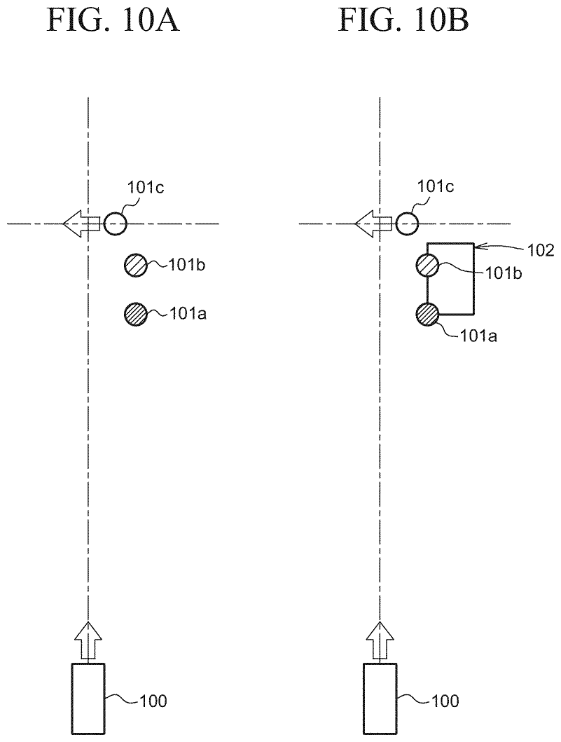

FIGS. 10A and 10B are diagrams each illustrating a positional relationship between the mobile object 100 on which the radar system 1 of the present embodiment is mounted and radio wave reflection sources (target objects) 101a, 101b, 101c. The radio wave reflection source 101a is a high reflective object in a stationary state, the radio wave reflection source 101b is a medium reflective object in a stationary state, and the radio wave reflection source 101c is a low reflective object moving in a direction orthogonal to the traveling direction of the mobile object 100. For example, as illustrated in FIG. 10B, it is conceivable that the radio wave reflection sources 101a, 101b form a part of another mobile object 102, and the radio wave reflection source 101c is a pedestrian who is about to cross a road from the back of another mobile object 102.

The relative speed measured by the radar system 1 is a speed component in a radial direction around the radar system 1. Therefore, the relative speed of the radio wave reflection source 101c is substantially equal to the relative speed of the radio wave reflection sources 101a, 101b in the stationary state, has the same magnitude as the relative speed of the mobile object 100 on which the radar system 1 is mounted, and has the opposite direction (sign). The speed frequencies of the three radio wave reflection sources 101a, 101b, 101c all have substantially the same discrete frequency value in the three-dimensional discrete frequency spectrum Γ(fᵣ, fᵥ, f_{θ}), and each have a local maximum value in the speed frequency direction.

At this time, if the three-dimensional discrete frequency spectrum Γ(fᵣ, fᵥ, f_{θ}) can have a sharp spectrum shape in the direction of the angular frequency f_{θ}, the three radio wave reflection sources 101a, 101b, 101c can be easily identified. However, in order to obtain a sharp spectrum shape, it is generally necessary to increase the overall length of the antenna array 20 in the radar system 1 and to densely arrange the receiving antenna elements 21₀, . . . , and 21_{Q-1}. In a case in which the size of the antenna array 20 is limited by the size of the mobile object 100 on which the radar system 1 is mounted, the entire length of the antenna array 20 is limited. As a result, the spectrum shape near the local maximum point in the direction of the angular frequency f_{θ} is not sharpened, and as illustrated in FIG. 8, the intensity distribution Sc2 of the radio wave reflection source 101c located at the farthest position from the radar system 1 may not form a peak in the direction of the distance frequency fᵣ. Even in such a case, the radar system 1 of the present embodiment can identify the radio wave reflection source 101c corresponding to the radio wave reflection source 101c by detecting the maximum distribution in the direction of the distance frequency fᵣ of the inclined portion Gc of the intensity distribution Sc2.

Although embodiments according to the present invention have been described above with reference to the drawings, the above embodiments are examples of the present invention, and there may be various embodiments other than the above embodiments. It should be noted that the invention of the present application is capable of modifying any of the constituent elements of the embodiment or omitting any of the constituent elements of the embodiment within the scope of the invention.

### INDUSTRIAL APPLICABILITY

The radar signal processing device, the radar system, and the signal processing method according to the present invention can be used for, for example, a radar system mounted on a mobile object such as an automobile.

### REFERENCE SIGNS LIST

1: radar system, 10: transmission antenna, 11: transmitter, 12: voltage generation circuit, 13: voltage-controlled oscillator, 14: distribution circuit, 15: amplifier circuit, 20: antenna array, 21₀, . . . , 21_{Q-1}: receiving antenna element, 30₀, 30_{Q-1}: receiver, 31o, . . . , 31_{Q-1}: mixer, 32o, . . . , 32_{Q-1}: amplifier circuit, 33o, . . . , 33_{Q-1}: filter circuit, 34₀, . . . , 34_{Q-1}: A/D converter (ADC), 40: radar signal processing device, 41: signal storage unit, 42: calculation unit, 43: control unit, 50: frequency analysis unit, 51 to 53: orthogonal transformer, 55: target detection unit, 55A: peak detection unit, 55B: maximum distribution detecting unit, 56: target information calculating unit, 70: signal processing circuit, 71: processor, 72: memory, 73: storage device, 74: input and output interface circuit, 75: signal path, 100, 102: mobile object, 101a to 101c: radio wave reflection source.

1. A radar signal processing device used in a radar system including:
an antenna array that includes a plurality of antenna elements arranged spatially and receives, by the plurality of antenna elements, a series of frequency-modulated waves reflected by a target object present within a radar detection space; and a receiving circuit that performs signal processing on output signals of the plurality of antenna elements and outputs digital received signals of a plurality of channels, the radar signal processing device comprising:
a processor to execute a program; and
a memory to store the program which, when executed by the processor, performs processes of,
calculating a three-dimensional discrete frequency spectrum related to a first discrete frequency corresponding to a distance to the target object, a second discrete frequency corresponding to a relative speed of the target object, and a third discrete frequency corresponding to an angle of arrival of the series of frequency-modulated waves by performing, on the digital received signals, a first discrete orthogonal transform related to time, a second discrete orthogonal transform related to continuous numbers assigned to the series of frequency-modulated waves, and a third discrete orthogonal transform related to sequence numbers assigned to the plurality of antenna elements;
detecting, for a discrete frequency value of at least one first search frequency selected from among the first to third discrete frequencies, a discrete frequency value of a peak appearing in the three-dimensional discrete frequency spectrum in a direction of a second search frequency selected from among the first to third discrete frequencies;
focusing on a local intensity distribution including the peak and having a spread in directions of the first search frequency and the second search frequency, and determining whether or not the local intensity distribution forms a maximum distribution in the direction of the first search frequency; and
calculating information on the target using the discrete frequency value of the first search frequency and the discrete frequency value of the peak in a case in which it is determined that the local intensity distribution forms the maximum distribution.

2. The radar signal processing device according to claim 1, the processes further including, if a width of a range in which the maximum distribution is present in a direction of the second search frequency is larger than a threshold, calculating the information on the target using the discrete frequency value of the first search frequency and the discrete frequency value of the peak.

3. The radar signal processing device according to claim 1, the processes further including focusing on a distribution having an intensity larger than an intensity threshold as the local intensity distribution.

4. The radar signal processing device according to claim 1,
the processes further including:
detecting a local maximum value from among L discrete intensity values (L is a positive integer) of the three-dimensional discrete frequency spectrum in a direction of the second search frequency; and
detecting a discrete frequency value of the second search frequency corresponding to the local maximum value as a discrete frequency value of the peak if a difference absolute value between a K-th discrete intensity value (K is a predetermined positive integer smaller than L) from a largest discrete intensity value among the L discrete intensity values and a J-th discrete intensity value (J is a predetermined positive integer smaller than L-K) from a smallest discrete intensity value among the L discrete intensity values exceeds a threshold.

5. A radar system comprising:
a radar signal processing device according to claim 1;
the antenna array; and
the receiving circuit.

6. A signal processing method executed in a radar system including: an antenna array that includes a plurality of antenna elements arranged spatially and receives, by the plurality of antenna elements, a series of frequency-modulated waves reflected by a target object present within a radar detection space; and a receiving circuit that performs signal processing on output signals of the plurality of antenna elements and outputs digital received signals of a plurality of channels, the signal processing method comprising:
calculating a three-dimensional discrete frequency spectrum related to a first discrete frequency corresponding to a distance to the target object, a second discrete frequency corresponding to a relative speed of the target object, and a third discrete frequency corresponding to an angle of arrival of the series of frequency-modulated waves by performing, on the digital received signals, a first discrete orthogonal transform related to time, a second discrete orthogonal transform related to continuous numbers assigned to the series of frequency-modulated waves, and a third discrete orthogonal transform related to sequence numbers assigned to the plurality of antenna elements;
detecting, for a discrete frequency value of at least one first search frequency selected from among the first to third discrete frequencies, a discrete frequency value of a peak appearing in the three-dimensional discrete frequency spectrum in a direction of a second search frequency selected from among the first to third discrete frequencies;
focusing on a local intensity distribution including the peak and having a spread in directions of the first search frequency and the second search frequency, and determining whether or not the local intensity distribution forms a maximum distribution in the direction of the first search frequency; and
calculating information on the target using the discrete frequency value of the first search frequency and the discrete frequency value of the peak in a case in which it is determined that the local intensity distribution forms the maximum distribution.

7. The radar signal processing device according to claim 2, the processes further including focusing on a distribution having an intensity larger than an intensity threshold as the local intensity distribution.

8. The radar signal processing device according to claim 2, the processes further including:
detecting a local maximum value from among L discrete intensity values (L is a positive integer) of the three-dimensional discrete frequency spectrum in a direction of the second search frequency; and
detecting a discrete frequency value of the second search frequency corresponding to the local maximum value as a discrete frequency value of the peak if a difference absolute value between a K-th discrete intensity value (K is a predetermined positive integer smaller than L) from a largest discrete intensity value among the L discrete intensity values and a J-th discrete intensity value (J is a predetermined positive integer smaller than L-K) from a smallest discrete intensity value among the L discrete intensity values exceeds a threshold.

9. The radar signal processing device according to claim 7, the processes further including:
detecting a local maximum value from among L discrete intensity values (L is a positive integer) of the three-dimensional discrete frequency spectrum in a direction of the second search frequency; and
detecting a discrete frequency value of the second search frequency corresponding to the local maximum value as a discrete frequency value of the peak if a difference absolute value between a K-th discrete intensity value (K is a predetermined positive integer smaller than L) from a largest discrete intensity value among the L discrete intensity values and a J-th discrete intensity value (J is a predetermined positive integer smaller than L-K) from a smallest discrete intensity value among the L discrete intensity values exceeds a threshold.

10. A radar system comprising:
a radar signal processing device according to claim 2;
the antenna array; and
the receiving circuit.

11. A radar system comprising:
a radar signal processing device according to claim 7;
the antenna array; and
the receiving circuit.

12. A radar system comprising:
a radar signal processing device according to claim 9;
the antenna array; and
the receiving circuit.
